(19) United States
(12) Patent Application Publication
(10) Pub. No.: US 2026/0333211 A1
(43) Pub. Date: Oct. 22, 2026

(54) Signaling and Cell Sleep Mode Configuration in Cell DTX/DRX

(71) Applicant: Apple Inc., Cupertino, CA (US)

(72) Inventors: Peng CHENG, Beijing (CN); Fangli XU, Beijing (CN); Haijing HU, Los Gatos, CA (US); Naveen Kumar R PALLE VENKATA, San Diego, CA (US); Ping-Heng KUO, London (GB); Ralf ROSSBACH, Munich (DE); Yuqin CHEN, Beijing (CN)

(21) Appl. No.: 19/101,493

(22) PCT Filed: Aug. 8, 2023
(86) PCT No.: PCT/US2023/029708

§ 371 Date: Feb. 5, 2025

Related U.S. Application Data
(60) Provisional application No. 63/370,706, filed on Aug. 8, 2022.

(51) Int. Cl. H04W 52/02; H04W 72/23

(52) U.S. Cl. CPC H04W 52/0206; H04W 72/23

(57) ABSTRACT

A user equipment (UE) configured to decode, from signaling received from a base station, a configuration for a cell ON-OFF pattern for a serving cell and a plurality of different cell sleep modes for an OFF duration of the ON-OFF pattern, wherein a first one of the cell sleep modes is indicated as a default sleep mode and each cell sleep mode is associated with different uplink (UL) or downlink (DL) communications that are allowed during the OFF duration, decode, from signaling received from the base station, a message changing the first cell sleep mode to a second cell sleep mode and perform a UL transmission (Tx), a DL reception (Rx), both the UL Tx and DL Rx, or neither the UL Tx nor DL Rx during the OFF duration in accordance with the second cell sleep mode.

### PRIORITY/INCORPORATION BY REFERENCE

This application claims priority to U.S. Provisional Application Ser. No. 63/370,706 filed on Aug. 8, 2022, and entitled “Signaling and Cell Sleep Mode Configuration in Cell DTX/DRX,” the entirety of which is incorporated herein by reference.

### BACKGROUND INFORMATION

A user equipment (UE) may establish a connection to at least one of a plurality of different networks or types of networks. For some types of network communications, the UE may be configured with a discontinuous reception (DRX) cycle or a discontinuous transmission (DTX) cycle to conserve power. The DRX/DTX cycle for the UE utilizes an active mode (ON duration) of data exchange processing and a sleep mode (OFF duration) of inactivity. A network cell (e.g., base station) can configure a DRX/DTX cycle for the UE and exchange communications with the UE, e.g., transmit downlink (DL) data/channels or reference signals and receive uplink (UL) transmissions, depending on the parameters of the DRX/DTX cycle(s) configured for the UE.

In 5G New Radio (NR), techniques can be implemented at the network cell (e.g., base station or gNB) to conserve power, including a cell DRX/DTX cycle where the gNB is configured with an active mode (ON duration) and a sleep mode (OFF duration). However, the signaling involved in implementing the cell DRX/DTX cycle, and the UE/gNB behavior when the cell DRX/DTX is configured, is not well defined.

### SUMMARY

Some exemplary embodiments are related to an apparatus of a user equipment (UE), the apparatus having processing circuitry configured to decode, from signaling received from a base station, a configuration for a cell ON-OFF pattern for a serving cell and a plurality of different cell sleep modes for an OFF duration of the ON-OFF pattern, wherein a first one of the cell sleep modes is indicated as a default sleep mode and each cell sleep mode is associated with different uplink (UL) or downlink (DL) communications that are allowed during the OFF duration, decode, from signaling received from the base station, a message changing the first cell sleep mode to a second cell sleep mode and perform a UL transmission (Tx), a DL reception (Rx), both the UL Tx and DL Rx, or neither the UL Tx nor DL Rx during the OFF duration in accordance with the second cell sleep mode.

Other exemplary embodiments are related to a processor configured to decode, from signaling received from a base station, a configuration for a cell ON-OFF pattern for a serving cell and a plurality of different cell sleep modes for an OFF duration of the ON-OFF pattern, wherein a first one of the cell sleep modes is indicated as a default sleep mode and each cell sleep mode is associated with different uplink (UL) or downlink (DL) communications that are allowed during the OFF duration, decode, from signaling received from the base station, a message changing the first cell sleep mode to a second cell sleep mode and perform a UL transmission (Tx), a DL reception (Rx), both the UL Tx and DL Rx, or neither the UL Tx nor DL Rx during the OFF duration in accordance with the second cell sleep mode.

Still further exemplary embodiments are related to an apparatus of a serving cell, the apparatus having processing circuitry configured to configure transceiver circuitry to transmit to a user equipment (UE) a configuration for a cell ON-OFF pattern for the serving cell and a plurality of different cell sleep modes for an OFF duration of the ON-OFF pattern, wherein a first one of the cell sleep modes is indicated as a default sleep mode and each cell sleep mode is associated with different uplink (UL) or downlink (DL) communications that are allowed during the OFF duration, configure transceiver circuitry to transmit a message to the UE changing the first cell sleep mode to a second cell sleep mode and perform a UL reception (Rx), a DL transmission (Tx), both the UL Rx and DL Tx, or neither the UL Rx nor DL Tx during the OFF duration in accordance with the second cell sleep mode.

Additional exemplary embodiments are related to a processor configured to configure transceiver circuitry to transmit to a user equipment (UE) a configuration for a cell ON-OFF pattern for the serving cell and a plurality of different cell sleep modes for an OFF duration of the ON-OFF pattern, wherein a first one of the cell sleep modes is indicated as a default sleep mode and each cell sleep mode is associated with different uplink (UL) or downlink (DL) communications that are allowed during the OFF duration, configure transceiver circuitry to transmit a message to the UE changing the first cell sleep mode to a second cell sleep mode and perform a UL reception (Rx), a DL transmission (Tx), both the UL Rx and DL Tx, or neither the UL Rx nor DL Tx during the OFF duration in accordance with the second cell sleep mode.

### BRIEF DESCRIPTION OF THE DRAWINGS

FIG. 1 shows a timing diagram for a DTX/DRX cycle for a cell according to one example.

FIG. 2 shows a timing diagram for a DTX/DRX cycle for a cell according to various exemplary embodiments.

FIG. 3 shows an exemplary method for signaling and configuration of cell DTX/DRX according to various exemplary embodiments.

FIG. 4 shows an exemplary network arrangement according to various exemplary embodiments.

FIG. 5 shows an exemplary base station according to various exemplary embodiments.

FIG. 6 shows an exemplary UE according to various exemplary embodiments.

### DETAILED DESCRIPTION

The exemplary embodiments may be further understood with reference to the following description and the related appended drawings, wherein like elements are provided with the same reference numerals. The exemplary embodiments relate to operations for configuring a discontinuous reception and/or discontinuous transmission (DRX/DTX) cycle for a network cell, e.g., gNB, where the gNB is configured with an active mode (ON duration) of data exchange with one or more user equipment (UE) and a sleep mode (OFF duration) of inactivity, where a power amplifier (PA) and radiofrequency (RF) front end are powered off. In one aspect, the exemplary embodiments describe the configuration and switching of a gNB sleep mode defining the gNB and UE behavior during the OFF duration of the cell DTX/DRX cycle. In another aspect, the exemplary embodiments describe signaling, e.g., group common (GC) signaling for switching the qNB sleep mode for a group of UES. In still another aspect, a group of UEs can be indicated to reselect to a neighbor cell utilizing a gNB sleep state (or non-sleep state) that can better serve the UEs in the group, based on, e.g., requirements or capabilities of the UEs.

The exemplary embodiments describe signaling operations for configuring the cell DRX/DTX cycles and the associated gNB sleep mode for a UE. The UE behaviors during the cycles can include, e.g., the transmission of certain types of downlink (DL) signaling/traffic and/or uplink (UL) signaling/traffic. In another aspect, the UE can provide assistance information to the cell with regard to the UE preference for switching a gNB sleep state during the cell DRX/DTX cycle or receiving a redirection to a neighbor cell.

The exemplary embodiments are described with regard to a UE. However, the use of a UE is merely provided for illustrative purposes. The exemplary embodiments may be utilized with any electronic component that is configured with the hardware, software, and/or firmware to exchange information (e.g., control information) and/or data with the network. Therefore, the UE as described herein is used to represent any suitable electronic device.

The exemplary embodiments are also described with regard to a 5G New Radio (NR) radio access network (RAN). However, reference to a 5G NR RAN is merely provided for illustrative purposes. The exemplary embodiments may be utilized with any network implementing DRX/DTX cycles similar to those described herein. Therefore, the 5G NR network as described herein may represent any type of network implementing similar DRX/DTX functionalities as the 5G NR network.

A DRX cycle can be configured for a UE according to existing methodologies to conserve UE power. The DRX cycle utilizes an active mode of data exchange processing and a sleep mode of inactivity. The UE may use the active mode of processing at defined intervals to perform scheduled operations such as performing measurements related to the network conditions, transmitting (e.g., requests, measurement reports, uplink data etc.), and receiving (e.g., control channel information, reference signals, synchronization signals, downlink data, etc.). The time period that the UE may be scheduled to receive may be referred to as the ON duration for the DRX cycle, or a DRX active time. The ON duration for a DRX cycle relates to a duration during which the UE may perform operations that enable the UE to receive data that may be transmitted to the UE such as but not limited to, control channel information, an uplink grant, a downlink grant, reference signals, synchronization signals, payload data etc.

During the DRX cycle, when an ON duration is not scheduled, the UE may have an opportunity to utilize the sleep mode of inactivity and conserve power. This period may be referred to as a DRX inactive time. However, reference to a DRX cycle is for illustrative purposes, and different networks may refer to similar concepts by a different name. The DRX cycle may have a predetermined duration N such as 100 milliseconds (ms), 50 ms, 40 ms, 20 ms, etc. For example, at a time 0, there may be a ON duration during which the active mode of processing is used. Subsequently, upon the conclusion of the ON duration, the UE has an opportunity to utilize the sleep mode of inactivity. Then at a time N, there may be another ON duration. Subsequently, the sleep mode is used until a time 2N. This process continues for the duration of the DRX cycle. Reference to the sleep mode of inactivity does not necessarily mean putting the processor, the transmitter, and the receiver of the UE to sleep, in hibernation, or in deactivation. For example, the processor (e.g., baseband and/or application) may continue to execute other applications or processes. The sleep mode relates to conserving power by discontinuing a continuous processing functionality relating to operations that enable the UE to receive data that may be transmitted to the UE and transmit data to the network. Further, reference to the DRX cycle being configured in ms units is merely for illustrative purposes, the exemplary aspects may utilize a DRX cycle that is based on subframes or any other suitable unit of time.

In Rel-18, techniques can be implemented on both the gNB and user equipment (UE) side to improve network energy consumption, e.g., base station transmission and reception power. These techniques may include more efficient dynamic and/or semi-static operations and finer granularity adaptation of transmissions and/or receptions and relate to the time, frequency, spatial, and/or power domains, with potential support/feedback from the UE, and potential UE assistance information. The techniques may further include information exchange/coordination over network interfaces. Additional/other techniques are not precluded. Idle/empty and low/medium load scenarios can be considered (the exact definition of such loads has not yet been defined), and different loads among carriers and neighbor cells are allowed.

In some examples, the power saving techniques can include gNB (cell) discontinuous transmission (DTX) and/or discontinuous reception (DRX) (or ON-OFF pattern) and uplink (UL) wakeup signal (WUS). Similar to the UE DRX cycle described above, a cell DTX/DRX can utilize an ON duration wherein the gNB can transmit/receive signals/channels and an OFF duration wherein the gNB can disable some types of signal Rx/Tx processing and conserve power. Cell DTX/DRX can be applied to the UE in all RRC states (IDLE, INACTIVE, or CONNECTED) and covers both transmit (Tx) and receive (Rx) of the gNB. The signaling design for implementing cell DTX/DRX should consider the RRC state of the UE and should also consider impacts to legacy UEs.

FIG. 1 shows a timing diagram 100 for a DTX/DRX cycle 102 for a cell, e.g., a gNB, according to one example. Each cell DTX/DRX cycle 102 comprises an ON duration 104, during which the power amplifier (PA) and radiofrequency (RF) front end of the gNB are powered on, and an OFF duration 106 when the PA and RF are turned off and the gNB can conserve power. The duration of the cell DTX/DRX cycle 102, and the length of the ON duration 104 relative to the OFF duration 106, can vary.

In some scenarios, e.g., when the gNB DTX/DRX cycle 102 is long, the UE performance can be impacted. For example, for UEs with high priority traffic, the quality of service (QoS) requirements of these traffic flows may not be satisfied if these traffics arrive at the UE during the OFF duration 106 of the cycle 102 (when the gNB is sleeping). In another example, UEs expecting to have priority service (e.g., “golden members”) may see an undesirable reduction in performance.

As will be described in further detail below, according to the exemplary embodiments described herein, different types of gNB sleep modes can be defined during the cell DRX/DTX OFF duration. Each of the different types of sleep modes can correspond to different levels of gNB power consumption. Thus, in some scenarios, the gNB sleep mode can be configured/switched according to the requirements of the UEs in the cell. In another aspect of these exemplary embodiments, the gNB can redirect one or more UEs to perform cell reselection and switch to another cell if, for example, the cell DRX/DTX cycle of the gNB will cause performance issues for the UE.

A major contributor to gNB power consumption includes random access (RACH) messages, scheduling requests (SR) and configured grant physical uplink shared channel (CG-PUSCH) receptions, for which the gNB needs to perform blind detection. Thus, in some embodiments, these types of communications can be allowed for one or some of the gNB sleep modes so that, for example, a UE having strict QoS requirements and/or high priority can transmit on the UL or receive on the DL during the long ON duration of the cell. Additionally, the gNB can activate/switch the gNB sleep mode for only a subset of the UEs in the cell, e.g., one or more UE groups, based on certain grouping criteria to be explained below.

According to various exemplary embodiments described herein, a UE can receive a configuration for a cell DTX/DRX cycle. The configurations for the cell DTX/DRX cycle can be received via, e.g., a system information block (SIB) and/or dedicated RRC signaling. The configuration can also include one or more gNB sleep modes for the cell DTX/DRX cycle. In some embodiments, the cell DTX/DRX cycle can be temporarily disabled for a group of UEs or the gNB sleep mode can be changed via group common (GC) signaling. The GC signaling can also be used to redirect a group of UEs to another cell. In other aspects of these exemplary embodiments, UE behavior during the DRX/DTX cycle and UE assistance information are described.

In one option, the cell DTX/DRX cycle can be configured in SIB. The configuration provided in SIB can include: a cell-specific DTX/DRX cycle (e.g., ON-OFF pattern) for the serving cell; and a number of different gNB sleep modes that can be used or switched to during the OFF duration of the cell DTX/DRX cycle of the serving cell. In some embodiments, the configuration can further include, for one or more neighbor cells, a SS/PBCH block measurement timing configuration (SMTC), a DTX/DRX cycle, and associated gNB sleep modes for the neighbor cell(s). To be described in further detail below, this neighbor cell information can be used by the serving cell and/or UE to redirect the UE to one of the neighbor cells in a cell reselection procedure.

In another option, these configuration parameters can be provided in dedicated RRC signaling. In still another option, some of these parameters, e.g., the cell DTX/DRX cycle, can be configured in SIB and the other configuration parameters can be provided in dedicated RRC signaling. In still another option, the configuration parameters received in RRC signaling can override those received in SIB.

The gNB can choose, based on gNB implementation, whether to align the cell DTX/DRX ON-OFF pattern with the UE DRX pattern and/or the core network (CN) or radio access network (RAN) paging cycle(s). In some scenarios, it may be beneficial to align these cycles, e.g., to align the beginning of the ON durations for the various cycles. In other scenarios, it may not be necessary to align these cycles.

During the DRX/DTX OFF duration, different gNB sleep modes can be configured for the UE depending on, for example, the power consumption requirements and/or capabilities of different gNBs (e.g., the serving gNB and potentially neighboring gNBs). The sleep modes can correspond to varying levels of power consumption imposed by the transmission/reception of various types of signals/channels. It is noted that the gNB can configure different sleep modes for different groups of UEs based on various considerations including, e.g., the number of UEs in the cell and the requirements of the various UEs. In some arrangements, the gNB may have knowledge of the requirements/capabilities of neighboring gNBs and their corresponding cell DTX/DRX cycles and sleep modes and perform operations in dependence thereon. For example, a serving cell can direct one or more UEs to switch to a neighboring cell if, for example, the QoS requirements of the UEs are strict and the neighboring cell is operating in a non-sleep mode or a sleep mode that allows high priority traffic Tx/Rx. In another example, if neighboring gNBs are not considered or if no neighboring gNB is better equipped than the serving cell to handle the traffic of one or more UEs, then the serving cell can switch its sleep mode to accommodate these UEs.

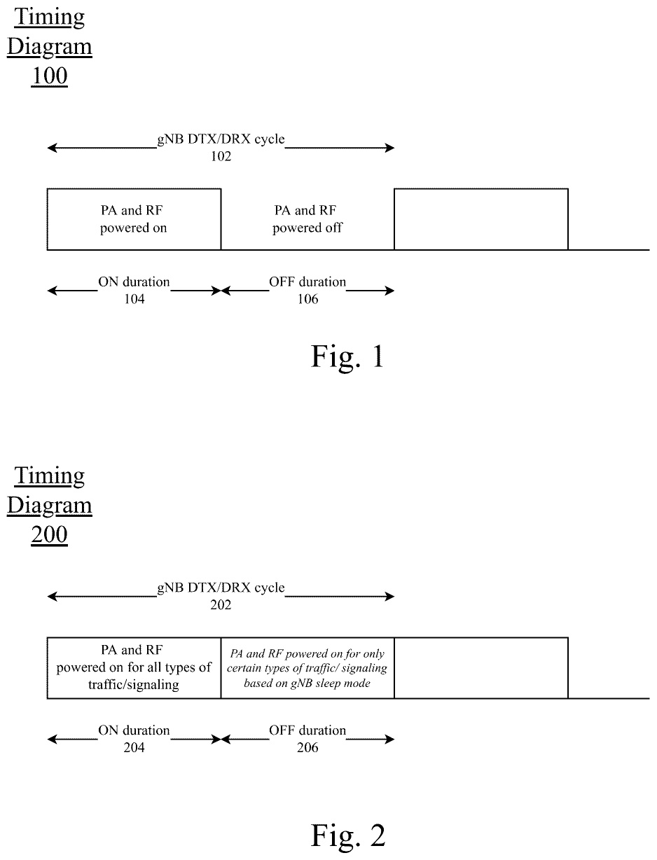

FIG. 2 shows a timing diagram 200 for a DTX/DRX cycle 202 for a cell, e.g., a gNB, according to various exemplary embodiments. Each cell DTX/DRX cycle 202 comprises an ON duration 204, during which the power amplifier (PA) and radiofrequency (RF) front end of the gNB are fully powered on and all types of traffic/signaling can be exchanged, and an OFF duration 206 when the gNB enters one of a plurality of available sleep modes. In the OFF duration, the PA and RF can be fully turned off, partially turned on for certain types of traffic/signaling, or fully powered on, as will be described below. The duration of the cell DTX/DRX cycle 202, and the length of the ON duration 204 relative to the OFF duration 206, can vary.

In one example, a non-sleep mode can be configured wherein the UE does not implement any configured cell DTX/DRX cycles. The UE can assume that legacy gNB operation can be followed. The non-sleep mode requires the gNB to expend the most power, relative to the sleep modes discussed below. The non-sleep mode can be used in high load scenarios where, for example, a large amount of high priority UE traffic is anticipated such that the gNB should continuously remain in an active state.

In a first sleep mode, the gNB DTX/DRX cycle is configured and no transmissions/receptions are allowed. The first sleep mode requires the gNB to expend the least power, relative to the further sleep modes discussed below and the non-sleep mode discussed above. IF the first sleep mode is configured for all the UEs in the cell then the gNB can turn off its RF and PA for an entirety of the DTX/DRX OFF duration. In other words, during the OFF duration, the gNB does not transmit reference signals (including SSB, CSI-RS, TRS, etc.), does not transmit DL data, and does not receive on the UL (including UL data grant, CG-PUSCH, RACH, SR and SRS). The UE configured with the first sleep mode will not expect to transmit/receive any of these signals/channels during the OFF duration.

In the following sleep modes (second, third and fourth sleep modes), certain types of transmissions/receptions are allowed during the OFF duration. Thus, during the OFF duration, the gNB may power on its RF front end and PA for some or all of the OFF duration. Depending on the types of transmissions/receptions allowed, the gNB may need to power on only certain modules of the RF/PA processing arrangement. Thus, some energy savings can be realized in these sleep modes relative to the non-sleep mode.

In the second sleep mode, only SSB transmission is allowed on the DL and no DL data transmission is allowed. Additionally, no UL reception (including UL grant, CG-PUSCH, RACH, SR and SRS) is allowed. In the third sleep mode, on the DL, only SSB transmission is allowed and no DL data transmission is allowed. On the UL, some periodic receptions (e.g., CG-PUSCH, RACH, SRS, and/or SR) are allowed and other types of reception are not allowed. In the fourth sleep mode, the SSB transmissions and periodic receptions of the third sleep mode are allowed, and, additionally, DL/UL scheduling for high priority service (e.g., URLLC) is allowed.

The UE can be configured with a particular gNB sleep mode in, for example, SIB or RRC, as described above. In some embodiments, multiple sleep modes can be provided in SIB/RRC where one of the sleep modes is initially configured and the UE can receive a later indication to switch to one of the other sleep modes, e.g., in an RRC message or dynamically in group common (GC) signaling.

A particular sleep mode may be configured only for some UEs in a cell, e.g., one or more groups of UEs. The membership in the UE groups can be determined based on network implementation. In one example, the UEs may be grouped by QoS. In another example, the UEs may be grouped by capability. The cell may determine only two groups, e.g., UEs with URLLC capabilities and UEs without such capabilities. In another example, the UEs may be grouped by priority of service (e.g., “golden members” or not) or by priority of DRB or logical channel. In other embodiments, the number of groups can be larger and depend on other UE and/or network considerations. In still other embodiments, some UEs can belong to multiple groups.

The UE grouping(s) can be configured in RRC or can be configured by the access and mobility management function (AMF) of the core network (CN), for example, in a manner similar to group paging specified in Rel-17 UE power saving. The AMF can include a configuration of several UE groups and their group members in the NAS message towards the UE.

In one embodiment, the gNB can associate each group of UEs with a code point and provide the UEs in the cell, e.g., via a UE-dedicated RRC message, with a mapping of each code point to a UE group index and an identification of members in the UE group so that the UE can determine to which group(s) the UE belongs. The grouping configuration can also include a gNB sleep mode associated with the code point of the group and, in some embodiments, a duration for the sleep mode. If a gNB sleep mode is associated with a group index, this indicated sleep mode could override any default sleep mode indication received in, e.g., SIB. However, any sleep mode indication received in this RRC message could, in some embodiments, be further switched for the group by group common (GC) signaling or a further UE-dedicated RRC message that indicates the code point associated with a particular UE group to which the UE belongs.

The sleep mode change can be signaled in various ways including: a new group-common DCI (GC-DCI); a new MAC-CE sent with PDSCH associated to a group common (GC) RNTI; a combination of DCI and MAC-CE; or an RRC message.

The GC signaling or RRC message can indicate the UE to perform various actions. In one example, the UE is indicated to perform a temporary change of the gNB sleep mode in an upcoming one or more cell DTX/DRX OFF duration. For example, a group of UEs can be changed from the first gNB sleep mode (no DL/UL signals/channels allowed) to a different gNB sleep mode where some DL/UL is allowed.

The group of UEs that receive this indication may, for example, have priority service over other UEs in the cell. Thus, the UEs can perform some Tx/Rx and the gNB can power on its PA/RF to perform these communications during the DTX/DRX OFF duration. Although the gNB does not remain in a fully inactive state during the OFF duration, the gNB can anticipate when certain Tx/Rx is to occur during the OFF duration and power on only at certain times, depending on the types of transmissions and capabilities/requirements of the group of UEs.

The duration of the temporary gNB sleep mode change can be indicated in the GC signaling. The duration can be indicated directly in the GC signaling or multiple durations can be configured in RRC and mapped to one or two bits of GC signaling. Any UEs that are not indicated in the GC signaling can follow the gNB sleep mode initially configured in SIB/RRC, as described above.

The GC signaling can also indicate to a UE to redirect to a neighbor cell. As described above, DTX/DRX and sleep mode parameters can be configured for the UE for one or more neighbor cells in addition to the serving cell. The GC signaling can indicate one of the neighbor cells and the UE can prioritize this cell during a cell reselection procedure. All the UEs in a group can be triggered to reselect to another cell that is, for example, better equipped to handle the UE traffic in the group. In one example, a neighbor cell may be configured with a sleep mode that allows high priority UL/DL traffic. In another example, a neighbor cell may have no cell DTX/DRX cycle configured. In still another example, a serving gNB may determine that it should redirect the UEs but may not determine a particular cell to which the UE should reselect. In this case, or if a number of different neighbor cells are suitable for the UEs, a particular neighbor cell may not be indicated in the GC signaling and the UE may receive only an indication that cell reselection should be performed.

The redirection of the group of UEs, as described above, can improve the overall efficiency of the network by avoiding costly RRC signaling that would otherwise occur if a particular serving cell cannot satisfy the requirements of some UEs. Rather than requiring the transmission and reception of multiple RRC release messages, these UEs are triggered to redirect to another cell and in some cases prioritize a particular cell.

In another aspect of these exemplary embodiments, UE behaviors can be defined during the cell DRX/DTX cycles depending on the RRC state of the UE.

For UEs in the RRC IDLE or INACTIVE state, the gNB sleep mode configured in SIB can be followed. It is up to gNB implementation to ensure that UE paging occasions overlap with the cell DTX/DRX ON duration so that the IDLE/INACTIVE UEs can still receive paging even when cell DTX/DRX is configured. To dynamically change the gNB sleep mode, a short message can be used. The short message refers to a message sent via DCI 1_0 with CRC scrambled by P-RNTI. In current NR specification, the short message comprises 8 bits, wherein only 2 of the 8 bits are currently in use. Therefore, one or more of the remaining 6 bits can be allocated to change the gNB sleep mode for the IDLE/INACTIVE UE.

For UEs in the RRC connected state, the gNB sleep mode configured in SIB can be followed unless GC signaling is received that dynamically changes the sleep mode. When both cell DTX/DRX and UE DRX are configured for the UE, the UE behavior can follow any of the following options. In a first option, the UE monitors the PDCCH only at the intersection of the cell DTX/DRX ON duration and the UE DRX ON duration. In a second option, the UE follows the cell DTX/DRX pattern when configured and ignores the UE DRX pattern. In a third option, the UE follows the UE DRX pattern and ignores the cell DTX/DRX pattern. In this option, it is up to gNB implementation to align the UE DRX ON duration with the cell DTX/DRX ON duration.

In still another aspect of these exemplary embodiments, during a cell DRX/DTX ON duration, the UE can send assistance information to the gNB indicating its preference, for example, to switch the gNB sleep mode; for gNB blind detection to be performed in some upcoming (one or more) OFF duration(s); or to be redirected to another cell. The UE can determine its preference based on, e.g., the serving cell and neighbor cell DTX/DRX cycle parameters/length and/or sleep mode configuration. The UE assistance information can be sent, e.g., via a UE assistance IE (UAI) or via UL wakeup signal (WUS) signaling.

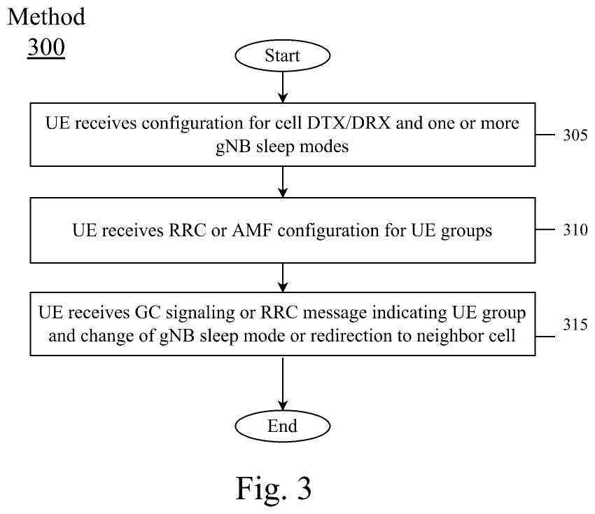

FIG. 3 shows an exemplary method 300 for signaling and configuration of cell DTX/DRX according to various exemplary embodiments.

In 305, the UE receives a cell DTX/DRX configuration (ON-OFF pattern) from a serving cell. In some embodiments, the configuration can include the cell-specific ON-OFF pattern and one or more different gNB sleep modes for the OFF duration of the serving cell. In some embodiments, the configuration can include parameters for neighbor cells including, e.g., a SMTC, a DTX/DRX cycle, and associated gNB sleep modes for the neighbor cell(s). This cell DTX/DRX configuration (for one or more cells) can be received from the serving cell via SIB, RRC, or a combination of SIB and RRC.

As described above, the gNB can configure a number of different sleep modes that allow varying amounts of UE traffic during the OFF duration of the cell DTX/DRX configuration, e.g., RS and/or DL reception, certain UL transmissions, etc. In some embodiments, the serving cell indicates a particular gNB sleep mode for the UE to use by default. The UE can follow this gNB sleep mode until a UE group configuration and/or a group-common (GC) signaling is received that, e.g., signals a switch of the gNB sleep mode.

If the UE is in the RRC IDLE or INACTIVE state, the UE can follow the cell DTX/DRX configuration from SIB and listen for paging messages during the UE DRX ON duration. In some embodiments, a short message can be received to dynamically switch the gNB sleep mode for an IDLE or INACTIVE UE. If the UE is in the RRC CONNECTED state, and a UE DRX cycle is also configured, the UE can follow the cell DTX/DRX pattern, the UE DTX/DRX pattern, or monitor the PDCCH only at the intersection of the cell ON duration and the UE ON duration.

In 310, the UE receives an RRC configuration (or AMF configuration) from the serving cell comprising a UE group configuration. In some embodiments, the RRC configuration includes an index for a GC signaling bit and a mapping of each code bit to a UE group index and an identification of members in the UE group. From this information, the UE can determine to which group the UE belongs. The RRC configuration may also indicate a sleep mode change for the group. The RRC configuration may also indicate one or more durations for a sleep mode change, wherein each duration can be mapped to a code point in GC signaling. In other embodiments, the UE group configuration is received from the AMF.

The UE can follow the gNB sleep mode indicated in the RRC configuration (if included) until a (further) sleep mode change is received from the network. In some embodiments, the UE can indicate its preference for, or request, the gNB to switch the gNB sleep mode for the UE, to perform blind detection in one or more upcoming OFF duration(s), or to redirect the UE to another cell. The UE can indicate these preferences in UE assistance information sent via a UE assistance IE (UAI) or UL wakeup signaling (WUS). The UE can determine to send the UE assistance information if, for example, the UE has upcoming high priority traffic or if one of the neighbor cells included in the configuration parameters is determined by the UE to be more suitable than the serving cell.

In 315, the UE receives a message, e.g., GC signaling or RRC message (indicating the code point of the UE group to which the UE belongs), indicating the UE to either perform a change of the gNB sleep mode in an upcoming one or more cell DTX/DRX OFF duration(s) or to redirect to a neighbor cell. The message can comprise a new GC DCI, a new GC MAC-CE, or RRC. If the message indicates the UE to change the gNB sleep mode, the message can also indicate a duration for the (temporary) change. If the message indicates the UE to redirect to a neighbor cell, the message may further include an identifier for the neighbor cell. The UE may determine cell DTX/DRX parameters for the neighbor cell and switch to the neighbor cell without requiring an RRC release exchange with the serving cell.

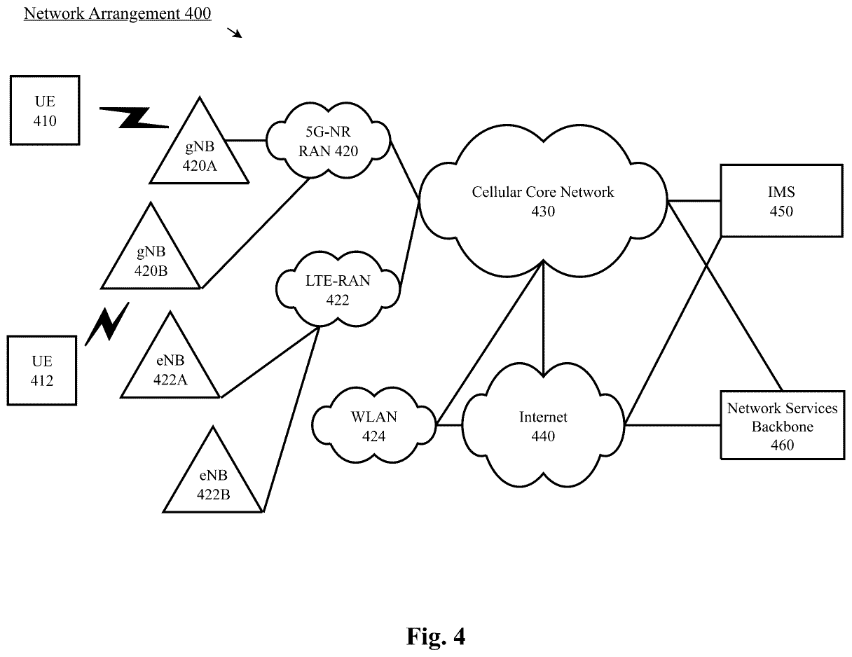

FIG. 4 shows an exemplary network arrangement 400 according to various exemplary embodiments. The exemplary network arrangement 400 includes UEs 410, 412. Those skilled in the art will understand that the UEs 410, 412 may be any type of electronic component that is configured to communicate via a network, e.g., mobile phones, tablet computers, desktop computers, smartphones, phablets, embedded devices, wearables (e.g., HMD, AR glasses, etc.), Internet of Things (IOT) devices, etc. It should also be understood that an actual network arrangement may include any number of UEs being used by any number of users. Thus, the example of two UEs 410, 412 is merely provided for illustrative purposes.

The UEs 410, 412 may communicate directly with one or more networks. In the example of the network configuration 400, the networks with which the UEs 410, 412 may wirelessly communicate are a 5G NR radio access network (5G NR-RAN) 420, an LTE radio access network (LTE-RAN) 422 and a wireless local access network (WLAN) 424. However, the UEs 410, 412 may also communicate with other types of networks and the UEs 410, 412 may also communicate with networks over a wired connection. Therefore, the UEs 410, 412 may include a 5G NR chipset to communicate UE 410 with the 5G NR-RAN 420, an LTE chipset to communicate with the LTE-RAN 422 and an ISM chipset to communicate with the WLAN 424.

The 5G NR-RAN 420 and the LTE-RAN 422 may be portions of cellular networks that may be deployed by a network carrier (e.g., Verizon, AT&T, T-Mobile, etc.). These networks 420, 422 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 424 may include any type of wireless local area network (WiFi, Hot Spot, IEEE 802.11x networks, etc.).

The UEs 410, 412 may connect to the 5G NR-RAN via the gNB 420A or the gNB 420B. Reference to two gNBs 420A, 420B is merely for illustrative purposes. The exemplary embodiments may apply to any appropriate number of gNBs. The UEs 410, 412 may also connect to the LTE-RAN 422 via the eNBs 422A, 422B. Those skilled in the art will understand that any association procedure may be performed for the UEs 410, 412 to connect to the 5G NR-RAN 420 and the LTE-RAN 422. For example, as discussed above, the 5G NR-RAN 420 and the LTE-RAN 422 may be associated with a particular cellular provider where the UEs 410, 412 and/or the user thereof has a contract and credential information (e.g., stored on a SIM card). Upon detecting the presence of the 5G NR-RAN 420, the UEs 410, 412 may transmit the corresponding credential information to associate with the 5G NR-RAN 420. More specifically, the UEs 410, 412 may associate with a specific base station (e.g., the gNB 420A of the 5G NR-RAN 420, the eNB 422A of the LTE-RAN 422).

In addition to the networks 420, 422 and 424 the network arrangement 400 also includes a cellular core network 430, the Internet 440, an IP Multimedia Subsystem (IMS) 450, and a network services backbone 460. The cellular core network 430 may be considered to be the interconnected set of components that manages the operation and traffic of the cellular network. The cellular core network 430 also manages the traffic that flows between the cellular network and the Internet 440. The IMS 450 may be generally described as an architecture for delivering multimedia services to the UE 410 using the IP protocol. The IMS 450 may communicate with the cellular core network 430 and the Internet 440 to provide the multimedia services to the UE 410. The network services backbone 460 is in communication either directly or indirectly with the Internet 440 and the cellular core network 430. The network services backbone 460 may be generally described as a set of components (e.g., servers, network storage arrangements, etc.) that implement a suite of services that may be used to extend the functionalities of the UEs 410, 412 in communication with the various networks.

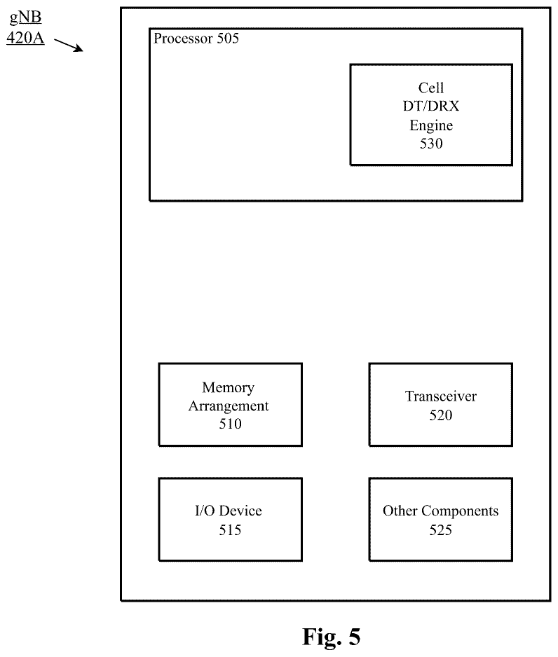

FIG. 5 shows an exemplary base station 420A according to various exemplary embodiments. The base station 420A will be described with regard to the network arrangement 400 of FIG. 4. The base station 420A may represent any access node through which the UE 410 may establish a connection and manage network operations. The base station 420A may also represent the gNB 420B described above with respect to FIG. 4.

The base station 420A may include a processor 505, a memory arrangement 510, an input/output (I/O) device 515, a transceiver 520, and other components 525. The other components 525 may include, for example, a battery, a data acquisition device, ports to electrically connect the base station 420A to other electronic devices, etc.

The processor 505 may be configured to execute a plurality of engines of the base station 420A. For example, the engines may include a cell DTX/DRX engine 530 for performing operations related to configuring a cell DTX/DRX cycle for a UE and a cell sleep mode for an OFF duration of the cycle, as described above.

The above noted engine 530 being an application (e.g., a program) executed by the processor 505 is only exemplary. The functionality associated with the engine 530 may also be represented as a separate incorporated component of the base station 420A or may be a modular component coupled to the base station 420A, e.g., an integrated circuit with or without firmware. For example, the integrated circuit may include input circuitry to receive signals and processing circuitry to process the signals and other information. In addition, in some base stations, the functionality described for the processor 505 is split among a plurality of processors (e.g., a baseband processor, an applications processor, etc.). The exemplary embodiments may be implemented in any of these or other configurations of a base station.

The memory 510 may be a hardware component configured to store data related to operations performed by the base station 420A. The I/O device 515 may be a hardware component or ports that enable a user to interact with the base station 420A.

The transceiver 520 may be a hardware component configured to exchange data with the UE 410 and any other UE in the system 400. The transceiver 520 may operate on a variety of different frequencies or channels (e.g., set of consecutive frequencies). Therefore, the transceiver 520 may include one or more components (e.g., radios) to enable the data exchange with the various networks and UEs. The transceiver 520 includes circuitry configured to transmit and/or receive signals (e.g., control signals, data signals). Such signals may be encoded with information implementing any one of the methods described herein. The processor 505 may be operably coupled to the transceiver 520 and configured to receive from and/or transmit signals to the transceiver 520. The processor 305 may be configured to encode and/or decode signals (e.g., signaling from a UE) for implementing any one of the methods described herein.

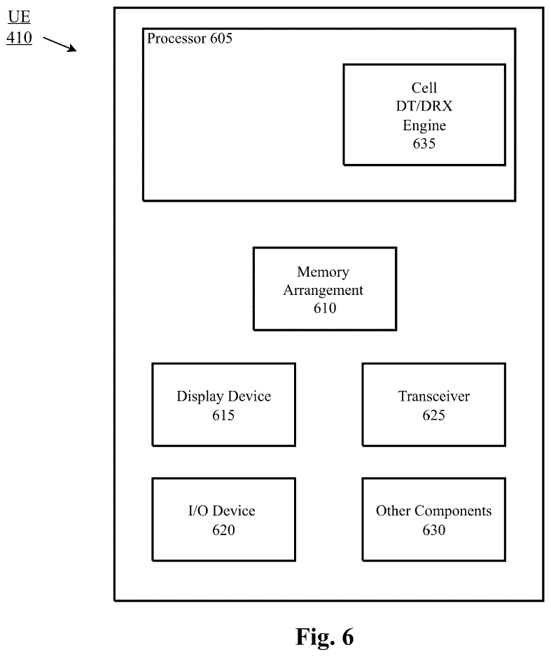

FIG. 6 shows an exemplary UE 410 according to various exemplary embodiments. The UE 410 will be described with regard to the network arrangement 400 of FIG. 4. The UE 410 may also represent UE 412. The UE 410 may include a processor 605, a memory arrangement 610, a display device 615, an input/output (I/O) device 620, a transceiver 625 and other components 630. The other components 630 may include, for example, an audio input device, an audio output device, a power supply, a data acquisition device, ports to electrically connect the UE 410 to other electronic devices, etc.

The processor 605 may be configured to execute a plurality of engines of the UE 410. For example, the engines may include a cell DTX/DRX engine 635 for performing various operations related to receiving a configuration for a cell DTX/DRX cycle and a gNB sleep mode during an OFF duration of the cycle, as described above.

The above referenced engine 635 being an application (e.g., a program) executed by the processor 605 is provided merely for illustrative purposes. The functionality associated with the engine 635 may also be represented as a separate incorporated component of the UE 410 or may be a modular component coupled to the UE 410, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 605 is split among two or more processors such as a baseband processor and an applications processor. The exemplary embodiments may be implemented in any of these or other configurations of a UE.

The memory arrangement 610 may be a hardware component configured to store data related to operations performed by the UE 410. The display device 615 may be a hardware component configured to show data to a user while the I/O device 620 may be a hardware component that enables the user to enter inputs. The display device 615 and the I/O device 620 may be separate components or integrated together such as a touchscreen.

The transceiver 625 may be a hardware component configured to establish a connection with the 5G NR-RAN 420 and/or any other appropriate type of network. Accordingly, the transceiver 625 may operate on a variety of different frequencies or channels (e.g., set of consecutive frequencies). The transceiver 625 may encompass an advanced receiver (e.g., E-MMSE-RC, R-ML, etc.) for MU-MIMO. The transceiver 625 includes circuitry configured to transmit and/or receive signals (e.g., control signals, data signals). Such signals may be encoded with information implementing any one of the methods described herein. The processor 605 may be operably coupled to the transceiver 625 and configured to receive from and/or transmit signals to the transceiver 625. The processor 605 may be configured to encode and/or decode signals (e.g., signaling from a base station of a network) for implementing any one of the methods described herein.

### EXAMPLES

In a first example, a method is performed by a user equipment (UE), comprising receiving a configuration for a cell ON-OFF pattern for a serving cell and a plurality of different cell sleep modes for an OFF duration of the ON-OFF pattern, wherein a first one of the cell sleep modes is indicated as a default sleep mode and each cell sleep mode is associated with different uplink (UL) or downlink (DL) communications that are allowed during the OFF duration, receiving a message changing the first cell sleep mode to a second cell sleep mode and performing a UL transmission (Tx), a DL reception (Rx), both the UL Tx and DL Rx, or neither the UL Tx nor DL Rx during the OFF duration in accordance with the second cell sleep mode.

In a second example, the method of the first example, wherein the configuration for the cell ON-OFF pattern and the plurality of different sleep modes is received in a system information block (SIB), radio resource control (RRC) message, or combination of SIB and RRC.

In a third example, the method of the first example, further comprising receiving a configuration for a plurality of UE groups and determining to which one of the plurality of UE groups the UE belongs.

In a fourth example, the method of the third example, wherein the configuration for the plurality of UE groups includes an index for multiple GC signaling code points and a mapping of each code point to a UE group index and an identification of members of the UE group.

In a fifth example, the method of the fourth example, wherein the configuration for the plurality of UE groups is received via RRC or an access and mobility management function (AMF).

In a sixth example, the method of the fourth example, wherein the plurality of UE groups are determined according to quality of service (QoS) requirements, priority, or capabilities.

In a seventh example, the method of the fourth example, wherein the message changing the first cell sleep mode to the second cell sleep mode comprises an indication of the UE group to which the UE belongs and identifies the second cell sleep mode.

In an eighth example, the method of the seventh example, wherein the message further comprises a duration for the second cell sleep mode and, after the duration, the second cell sleep mode is changed back to the first cell sleep mode.

In a ninth example, the method of the first example, wherein the plurality of cell sleep modes comprise a non-sleep mode wherein the configured cell ON-OFF pattern is ignored; a no Tx or Rx sleep mode where no Tx or Rx is allowed; a system synchronization block (SSB) sleep mode where only SSB reception is allowed; periodic UL sleep mode where the SSB reception and periodic UL transmission is allowed; or a DL and UL scheduling sleep mode where the SSB reception, the periodic UL transmission, and DL and UL scheduling is allowed.

In a tenth example, the method of the ninth example, wherein the periodic UL sleep mode allows for the UL transmission of scheduling requests (SR), sounding reference signals (SRS), random access (RACH) messages and configured grant physical uplink shared channels (CG-PUSCH).

In an eleventh example, the method of the tenth example, wherein the DL and UL scheduling sleep mode allows for DL reception and UL transmission of high priority traffic.

In a twelfth example, the method of the first example, wherein the message is received via a group common (GC) downlink control information (DCI), a GC medium access control (MAC) control element (MAC-CE), a combination of the GC DCI and the GC MAC-CE, or a radio resource control (RRC) message.

In a thirteenth example, the method of the first example, wherein, when the UE is in a radio resource control (RRC) IDLE or INACTIVE state, the first sleep mode is followed until the UE transitions into the RRC CONNECTED state and receives the message.

In a fourteenth example, the method of the first example, wherein, when the UE is in a radio resource control (RRC) IDLE or INACTIVE state, the message comprises a short message in downlink control information (DCI) format 0_1.

In a fifteenth example, the method of the first example, wherein, when the UE is in a radio resource control (RRC) CONNECTED state, the first sleep mode is followed until the UE receives the message.

In a sixteenth example, the method of the first example, wherein, when the UE is in a radio resource control (RRC) CONNECTED state and a UE ON-OFF pattern is configured, the UE either follows the cell ON-OFF pattern, follows the UE ON-OFF pattern, or monitors a physical downlink control channel (PDCCH) only during an overlapping duration of the UE ON-OFF pattern and the cell ON-OFF pattern.

In a seventeenth example, the method of the first example, wherein, when the UE is in a radio resource control (RRC) CONNECTED state, the UE performs redirection to other cells until the UE receives the message.

In an eighteenth example, the method of the first example, further comprising transmitting a request or preference to the serving cell to switch a current sleep mode; for the serving cell to perform blind detection in an upcoming OFF duration; or to redirect the UE to another cell.

In a nineteenth example, the method of the eighteenth example, wherein the request or preference is transmitted via a UE assistance information element (IE) or UL wakeup signaling (WUS).

In a twentieth example, a processor configured to perform any of the methods of the first through nineteenth examples.

In a twenty first example, a user equipment (UE) comprising a transceiver configured to communicate with a network and a processor communicatively coupled to the transceiver and configured to perform any of the methods of the first through nineteenth examples.

In a twenty second example, a method performed by a serving cell, comprising transmitting to a user equipment (UE) a configuration for a cell ON-OFF pattern for the serving cell and a plurality of different cell sleep modes for an OFF duration of the ON-OFF pattern, wherein a first one of the cell sleep modes is indicated as a default sleep mode and each cell sleep mode is associated with different uplink (UL) or downlink (DL) communications that are allowed during the OFF duration, transmitting a message to the UE changing the first cell sleep mode to a second cell sleep mode and performing a UL reception (Rx), a DL transmission (Tx), both the UL Rx and DL Tx, or neither the UL Rx nor DL Tx during the OFF duration in accordance with the second cell sleep mode.

In a twenty third example, the method of the twenty second example, wherein the configuration for the cell ON-OFF pattern and the plurality of different sleep modes is received in a system information block (SIB), radio resource control (RRC) message, or combination of SIB and RRC.

In a twenty fourth example, the method of the twenty second example, further comprising transmitting a configuration for a plurality of UE groups so that the UE can determine to which one of the plurality of UE groups the UE belongs.

In a twenty fifth example, the method of the twenty fourth example, wherein the configuration for the plurality of UE groups includes an index for multiple GC signaling code points and a mapping of each code point to a UE group index and an identification of members of the UE group.

In a twenty sixth example, the method of the twenty fifth example, wherein the configuration for the plurality of UE groups is transmitted via RRC or an access and mobility management function (AMF).

In a twenty seventh example, the method of the twenty fifth example, wherein the plurality of UE groups are determined according to quality of service (QoS) requirements, priority, or capabilities.

In a twenty eighth example, the method of the twenty fifth example, wherein the message changing the first cell sleep mode to the second cell sleep mode comprises an indication of the UE group to which the UE belongs and identifies the second cell sleep mode.

In a twenty ninth example, the method of the twenty eighth example, wherein the message further comprises a duration for the second cell sleep mode and, after the duration, the second cell sleep mode is changed back to the first cell sleep mode.

In a thirtieth example, the method of the twenty second example, wherein the plurality of cell sleep modes comprise a non-sleep mode wherein the configured cell ON-OFF pattern is ignored; a no Tx or Rx sleep mode where no Tx or Rx is allowed; a system synchronization block (SSB) sleep mode where only SSB transmission is allowed; periodic UL sleep mode where the SSB transmission and periodic UL reception is allowed; or a DL and UL scheduling sleep mode where the SSB transmission, the periodic UL reception, and DL and UL scheduling is allowed.

In a thirty first example, the method of the thirtieth example, wherein the periodic UL sleep mode allows for the UL reception of scheduling requests (SR), sounding reference signals (SRS), random access (RACH) messages and configured grant physical uplink shared channels (CG-PUSCH).

In a thirty second example, the method of the thirty first example, wherein the DL and UL scheduling sleep mode allows for DL transmission and UL reception of high priority traffic.

In a thirty third example, the method of the twenty second example, wherein the message is transmitted via a group common (GC) downlink control information (DCI), a GC medium access control (MAC) control element (MAC-CE), a combination of the GC DCI and the GC MAC-CE, or a radio resource control (RRC) message.

In a thirty fourth example, the method of the twenty second example, wherein, when the UE is in a radio resource control (RRC) IDLE or INACTIVE state, the first sleep mode is followed until the UE transitions into the RRC CONNECTED state and receives the message.

In a thirty fifth example, the method of the twenty second example, wherein, when the UE is in a radio resource control (RRC) IDLE or INACTIVE state, the message comprises a short message in downlink control information (DCI) format 0_1.

In a thirty sixth example, the method of the twenty second example, wherein, when the UE is in a radio resource control (RRC) CONNECTED state, the first sleep mode is followed until the UE receives the message.

In a thirty seventh example, the method of the twenty second example, wherein, when the UE is in a radio resource control (RRC) CONNECTED state and a UE ON-OFF pattern is configured, the UE either follows the cell ON-OFF pattern, follows the UE ON-OFF pattern, or monitors a physical downlink control channel (PDCCH) only during an overlapping duration of the UE ON-OFF pattern and the cell ON-OFF pattern.

In a thirty eighth example, the method of the twenty second example, wherein, when the UE is in a radio resource control (RRC) CONNECTED state, the UE performs redirection to other cells until the UE receives the message.

In a thirty ninth example, the method of the twenty second example, further comprising receiving a request or preference to the serving cell to switch a current sleep mode; for the serving cell to perform blind detection in an upcoming OFF duration; or to redirect the UE to another cell.

In a fortieth example, the method of the thirty ninth example, wherein the request or preference is transmitted via a UE assistance information element (IE) or UL wakeup signaling (WUS).

In a forty first example, a processor configured to perform any of the methods of the twenty second through fortieth examples.

In an forty second example, a base station comprising a transceiver configured to communicate with a user equipment (UE) and a processor communicatively coupled to the transceiver and configured to perform any of the methods of the twenty second through fortieth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

1. An apparatus of a user equipment (UE), the apparatus comprising processing circuitry configured to:
decode, from signaling received from a base station, a configuration for a cell ON-OFF pattern for a serving cell and a plurality of different cell sleep modes for an OFF duration of the ON-OFF pattern, wherein a first one of the cell sleep modes is indicated as a default sleep mode and each cell sleep mode is associated with different uplink (UL) or downlink (DL) communications that are allowed during the OFF duration;
decode, from signaling received from the base station, a message changing the first cell sleep mode to a second cell sleep mode; and
perform a UL transmission (Tx), a DL reception (Rx), both the UL Tx and DL Rx, or neither the UL Tx nor DL Rx during the OFF duration in accordance with the second cell sleep mode.

2. The apparatus of claim 1, wherein the configuration for the cell ON-OFF pattern and the plurality of different sleep modes is received in a system information block (SIB), radio resource control (RRC) message, or combination of SIB and RRC.

3. The apparatus of claim 1, wherein the processing circuitry is further configured to:
decode, from signaling received from the base station, a configuration for a plurality of UE groups; and
determine to which one of the plurality of UE groups the UE belongs.

4. The apparatus of claim 3, wherein the configuration for the plurality of UE groups includes an index for multiple GC signaling code points and a mapping of each code point to a UE group index and an identification of members of the UE group.

5. The apparatus of claim 1, wherein the plurality of cell sleep modes comprise a non-sleep mode wherein the configured cell ON-OFF pattern is ignored; a no Tx or Rx sleep mode where no Tx or Rx is allowed; a system synchronization block (SSB) sleep mode where only SSB reception is allowed; periodic UL sleep mode where the SSB reception and periodic UL transmission is allowed; or a DL and UL scheduling sleep mode where the SSB reception, the periodic UL transmission, and DL and UL scheduling is allowed.

6. The apparatus of claim 5, wherein the periodic UL sleep mode allows for the UL transmission of scheduling requests (SR), sounding reference signals (SRS), random access (RACH) messages and configured grant physical uplink shared channels (CG-PUSCH).

7. The apparatus of claim 1, wherein the message is received via a group common (GC) downlink control information (DCI), a GC medium access control (MAC) control element (MAC-CE), a combination of the GC DCI and the GC MAC-CE, or a radio resource control (RRC) message.

8. The apparatus of claim 1, wherein, when the UE is in a radio resource control (RRC) IDLE or INACTIVE state, the first sleep mode is followed until the UE transitions into the RRC CONNECTED state and receives the message.

9. The apparatus of claim 1, wherein, when the UE is in a radio resource control (RRC) IDLE or INACTIVE state, the message comprises a short message in downlink control information (DCI) format 0_1.

10. The apparatus of claim 1, wherein, when the UE is in a radio resource control (RRC) CONNECTED state, the first sleep mode is followed until the UE receives the message.

11. The apparatus of claim 1, wherein, when the UE is in a radio resource control (RRC) CONNECTED state and a UE ON-OFF pattern is configured, the UE either follows the cell ON-OFF pattern, follows the UE ON-OFF pattern, or monitors a physical downlink control channel (PDCCH) only during an overlapping duration of the UE ON-OFF pattern and the cell ON-OFF pattern.

12. The apparatus of claim 1, wherein, when the UE is in a radio resource control (RRC) CONNECTED state, the UE performs redirection to other cells until the UE receives the message.

13. The apparatus of claim 1, wherein the processing circuitry is further configured to:
configure transceiver circuitry to transmit a request or preference to the serving cell to switch a current sleep mode; for the serving cell to perform blind detection in an upcoming OFF duration; or to redirect the UE to another cell, wherein the request or preference is transmitted via a UE assistance information element (IE) or UL wakeup signaling (WUS).

14. An apparatus of a serving cell, the apparatus comprising processing circuitry configured to:
configure transceiver circuitry to transmit to a user equipment (UE) a configuration for a cell ON-OFF pattern for the serving cell and a plurality of different cell sleep modes for an OFF duration of the ON-OFF pattern, wherein a first one of the cell sleep modes is indicated as a default sleep mode and each cell sleep mode is associated with different uplink (UL) or downlink (DL) communications that are allowed during the OFF duration;
configure transceiver circuitry to transmit a message to the UE changing the first cell sleep mode to a second cell sleep mode; and
perform a UL reception (Rx), a DL transmission (Tx), both the UL Rx and DL Tx, or neither the UL Rx nor DL Tx during the OFF duration in accordance with the second cell sleep mode.

15. The apparatus of claim 14, wherein the configuration for the cell ON-OFF pattern and the plurality of different sleep modes is received in a system information block (SIB), radio resource control (RRC) message, or combination of SIB and RRC.

16. The apparatus of claim 14, wherein the processing circuitry is further configured to:
configure transceiver circuitry to transmit a configuration for a plurality of UE groups so that the UE can determine to which one of the plurality of UE groups the UE belongs.

17. The apparatus of claim 16, wherein the configuration for the plurality of UE groups includes an index for multiple GC signaling code points and a mapping of each code point to a UE group index and an identification of members of the UE group.

18. The apparatus of claim 17, wherein the configuration for the plurality of UE groups is transmitted via RRC or an access and mobility management function (AMF).

19. The apparatus of claim 17, wherein the plurality of UE groups are determined according to quality of service (Qos) requirements, priority, or capabilities.

20. The apparatus of claim 17, wherein the message changing the first cell sleep mode to the second cell sleep mode comprises an indication of the UE group to which the UE belongs and identifies the second cell sleep mode.
